(19) United States
(12) Patent Application Publication
(10) Pub. No.: US 2008/0172336 A1
(43) Pub. Date: Jul. 17, 2008

(54) Content Distribution

(75) Inventor: Suresh Srinivasan, Bangalore (IN)

Correspondence Address: LAW FIRM OF NAREN THAPPETA, 158, PHASE ONE PALM MEADOWS, RAMAGUNDANAHALLI, AIRPORT WHITEFIELD ROAD, BANGALORE, 560066, omitted

(73) Assignee: Oracle International Corporation, Redwood Shores, CA (US)

(21) Appl. No.: 11/678,620

(22) Filed: Feb. 26, 2007

(30) Foreign Application Priority Data
Jan. 11, 2007 (IN) 68/CHE/2007

(51) Int. Cl. H04L 9/00

(52) U.S. Cl. 705/51

(57) ABSTRACT

A content distribution system stores encrypted content, an operating system, a decrypt application and a decrypt key on a portable storage device with a serial communication interface such as USB. The portable storage device may be connected to a hardware unit (containing a corresponding/compatible serial interface) designed to boot from the stored operating system. Upon booting, the operating system automatically retrieves the encrypted content, decrypt application and decrypt key, and executes the decrypt application to generate (by decrypting using the decrypt key) the source content, which is then reproduced/replayed on a suitable system such as a television. Content such as songs/movies etc., may thus be distributed efficiently on a relatively small-sized portable storage devices such as a USB thumb drive.

### RELATED APPLICATION

The present application is related to and claims priority from the co-pending India Patent Application entitled, “CONTENT DISTRIBUTION”, Serial Number: 68/CHE/2007, Filed: Jan. 11, 2007, docket number: ORCL-047/India, naming the same inventors as in the subject patent application, and is incorporated in its entirety herewith.

### BACKGROUND

Content is often distributed in electronic form. For example, a distribution outlet may rent audio (such as songs) and video (such as movies) content to a customer on a subscription basis or for a rental fee. In general, content can represent any one or more of text, audio, video, data, software programs, etc.

A distribution outlet may maintain stock (or has access to) of several copies of the same content material. For example, multiple copies of a movie may be stored on compact disks (CD). Alternatively, the movie may be stored in digital form in a computer, and copied on a suitable medium such as a compact disk (CD) or DVD (Digital Video Disc) when required. A customer may rent the copy of the movie stored on a CD/DVD, and play the movie on a desktop computer or a DVD player, often at home.

There is a general need to make content distribution user friendly as well as meet one or more of various requirements such as reduction of physical space required, restricting access to only desired/authorized users, etc., to the extent possible.

### BRIEF DESCRIPTION OF THE DRAWINGS

Various embodiments will be described with reference to the following accompanying drawings, which are described briefly below.

FIG. (FIG.) 1 is a block diagram illustrating an example environment in which several aspects of the present invention can be implemented.

FIG. 2 is a block diagram of a portable storage device in one embodiment.

FIG. 3 is a diagram illustrating the contents of a storage medium memory in one embodiment.

FIG. 4 is a flowchart illustrating the manner in which memory contents stored in a portable storage device are processed to reproduce/replay stored content units in one embodiment.

FIG. 5 is a block diagram of a user system designed to reproduce/replay content stored in a portable storage device.

FIG. 6 is a flowchart illustrating the manner in which a distribution system stores (distributes) source content units in an embodiment.

FIG. 7 is a block diagram illustrating the details of a system in which several features of the present invention are operative upon execution of corresponding software instructions, in one embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention enables video content (e.g., movies) to be distributed on a Universal Serial Bus (USB) Drive. In one embodiment, a hardware unit retrieves the digital data representing video content from the USB drive and generates video signals designed for processing by television systems. A television system may reproduce the content from the received video signals.

Due to the compactness of the USB drive in combination with simplicity with which data can be stored thereon, video content distribution is simplified.

Another aspect of the present invention provides enhanced control in distribution of content (including video content noted above). In an embodiment, a distribution system stores encrypted content along with an operating system, a decrypt application and a decrypt key in a storage medium (memory) in a portable storage device (e.g., USB drive noted above). The portable storage device may be connected to a hardware unit designed to boot from the stored operating system.

Upon loading (and execution) on the user system, the operating system is designed to automatically retrieve the encrypted content, decrypt application and decrypt key, and execute the decrypt application to decrypt the encrypted content to generate a source content. The source content is then reproduced/replayed on a suitable reproduction system such as a television unit.

By ensuring that the operating system executes the decrypt application automatically and since the decrypt keys can also be stored in any location consistent with the design of decrypt application, enhanced control may be provided in preventing unauthorized copying and/or use of the content.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

2. Example Environment

FIG. 1 is a block diagram of an example environment in which several aspects of the present invention may be implemented. The diagram is shown containing content repository 110, distribution system 130, portable storage devices 140A through 140N, and user systems 170A through 170N. Each component is described in detail below.

Content repository 110 contains (stores) content units which is provided to distribution system 130 on path 113. Content repository 110 may be, for example, a computer containing a database storing content units, such as audio(e.g., song) and video (e.g., movie). Although path 113 has been shown as a direct path, it must be understood that content repository 110 may provide content material to distribution system 130 via a network also.

Distribution system 130 retrieves content units from content repository 110, and stores (as denoted symbolically by dotted lines 134A through 134N respectively) the content units in portable storage devices 140A through 140N. Distribution system 130 may be implemented, for example, as a computer system (described further below in an embodiment), and may communicate with (and store content units on) portable storage devices 140A through 140N through a serial interface such as universal serial bus (USB) interface, SD(secure digital) card interface etc. Distribution system 130 may contain an external slot onto which portable storage devices 140A through 140N may be plugged to facilitate communication and content storage.

Content repository 110 and distribution system 130 may be located in a distribution outlet such as a video store. Alternatively, distribution system 130 may be located in a distribution outlet, while content repository 110 may be located at a remote site and connected to distribution system 130 via a network as noted above.

User systems 170A through 170N operate to reproduce/replay (as denoted symbolically by dotted lines 147A through 147N respectively) the content stored in portable storage devices 140A through 140N respectively. For example, each of user systems 170A through 170N may be a television or video display unit designed to reproduce/replay content stored in corresponding portable storage devices 140A through 140N, and may contain an external slot into which portable storage devices 140A through 140N may be plugged for retrieval of the stored content. An embodiment of user systems 170A through 170N is described in detail below.

Portable storage devices 140A through 140N provide a storage medium in which content units may be stored (by distribution system 130). Portable storage devices 140A through 140N then interface with user systems 170A through 170N to facilitate reproduction of the stored content. Each portable storage device 140A through 140N may be designed to interface with distribution system 130 via a serial interface such as universal serial bus (USB), SD (secure digital) card interface, etc.

According to an aspect of the present invention, the distribution of video content (movies) is simplified by choosing portable storage devices 140A through 140N to have a small size. In one embodiment, portable storage devices 140A through 140N is implemented based on Cruzer™ Titanium Drive available from SanDisk Corporation. The manner in which the video content can be stored and reproduced, is described in sections below.

According to another aspect of the present invention, sufficient information is stored in each portable storage device 140A through 140N to provide enhanced control over content distribution. The scope of such information can be appreciated in the context of the details of an example implementation of portable storage device, and accordingly the description is continued with respect to such detail.

3. Portable Storage Device

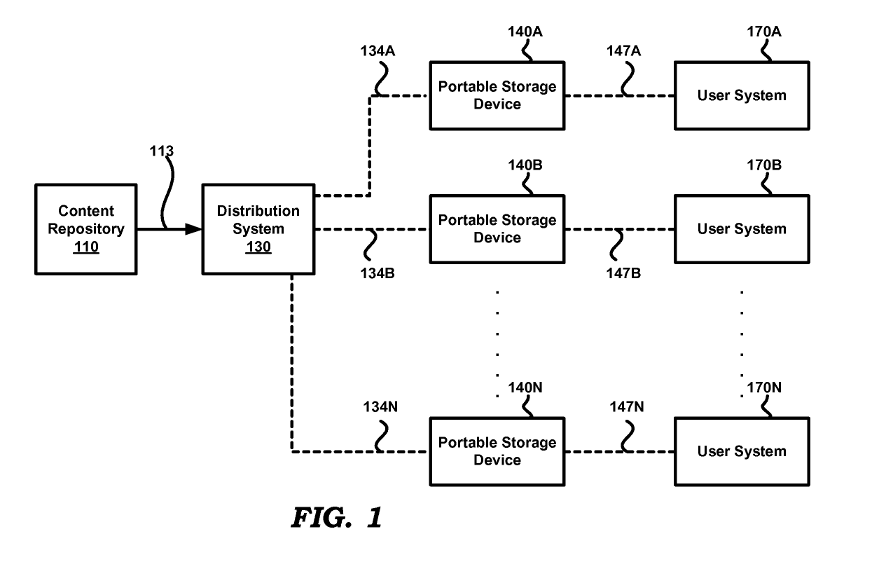

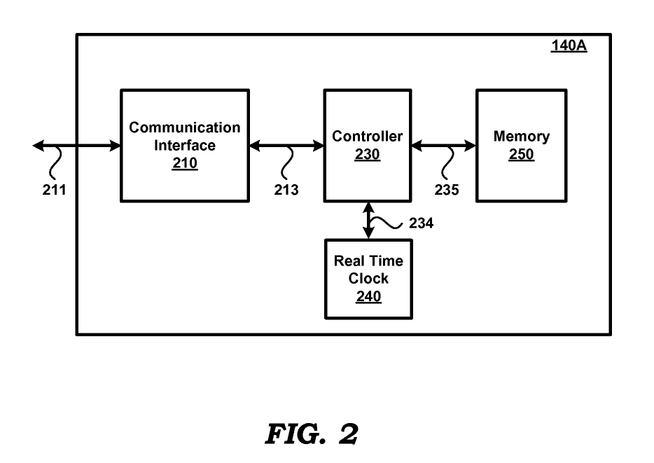

FIG. 2 is a block diagram of portable storage devices 140A through 140N in one embodiment. USB thumb drive and SD card are some example implementations of portable storage devices 140A through 140N. The diagram is described with respect to portable storage device 140A, and is shown containing communication interface 210, controller 230, real time clock (RTC) 240, and memory 250. Each component is described in detail below.

Communication interface 210 receives data stream from distribution system 130on path 211 in serial form on corresponding pins, and forwards the received data stream to controller 230 on path 213. Communication interface 210 may receive another data stream from controller 230 and forward the received data stream on path 211 (to user system 170A). Communication interface 210 may also receive (forward) control information from (to) controller 230 for establishing communication with the external device connected on path 211. Communication interface 210 may be implemented consistent with serial communication interfaces such as USB, SD card protocols etc.

Controller 230 receives data streams from via communication interface 210 via path 213, and stores the data streams in memory 250 via path 235. Controller 230 retrieves the data streams stored in memory 250, and processes the data to achieve a desired function. In particular, the received data streams may represent video content in encrypted form, an operating system, a decrypt application and a decrypt key. Controller 230 retrieves the stored data streams from memory 250 and provides the data stream to an external device connected on path 211, via communication interface 210. Controller 230 may also provide various control signals(not shown) to control/monitor the operation of communication interface 210 and memory 250.

Controller 230 may be implemented in the form of a microcontroller/microprocessor or, in general, in the form of a digital control logic. The logic may be controlled by software instructions stored in a ROM (not shown). The software instructions may be conveniently designed to protect unauthorized copying of at least some portions of memory 250.

Real time clock (RTC) 240 contains circuitry implementing a real time clock, and may be initialized and controlled by controller 230(via path 234) to set a current time and date (which may be provided, for example, from an external device via path 211). RTC 240 may contain a battery/cell in-built which powers circuitry in RTC 240 even when power to portable storage device 140A is removed.

Memory 250 (storage medium implemented, for example, in the form of a NAND flash memory well known in the relevant arts) stores data received from controller 230, and represents a machine readable medium storing instructions/data, which when retrieved and processed by a device (e.g., user system 170A) causes the content to be reproduced. The manner in which such a feature can be obtained in an example scenario is described below.

4. Memory Content

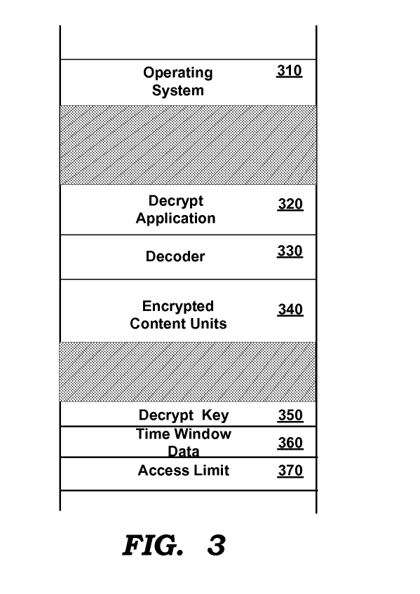

FIG. 3 is a diagram illustrating the content of memory 250 in one embodiment. Each of fields 310, 320, 330, 340, 350, 360 and 370 may represent one or more memory locations in memory 250, accessed via controller 230 (of FIG. 2). Areas in the diagram shown by hashed lines may be empty memory locations, or may contain other data/programs.

As shown in FIG. 3, field 340 contains content units in an encrypted form (encrypted content). The encrypted content is generated by an encryption application using one or more keys, prior to storing in field 340.

Field 320 contains a decrypt application designed to retrieve the data bits stored in fields 340 and 350, and decrypt the retrieved encrypted content using the retrieved key when executed. The decrypt application generally complements (reverse process) the encryption application that creates the encrypted content. It should be noted that decrypt key 350 can be placed in any memory location within memory 250 consistent with the retrieval logic of decrypt application 320, thereby reducing the probability of compromise of the key.

Field 330 contains a decoder application which converts a decrypted content (source content) to a format suitable for reproduction/replaying. The decoder application may alternatively be provided in the external device that generates the decrypted content.

Field 350 stores a decrypt key which is used by the decrypt application stored in field 320 to decrypt the encrypted content. The decrypt key may be a private key, with the corresponding public key (with the key pair being generated, for example, using the RSA algorithm well known in the relevant arts) being used (e.g., in distribution system 130) to generate the encrypted content stored in field 340.

Field 310 is shown containing an operating system, which when executed automatically (without permitting user discretion) invokes decrypt application (field 320) to decrypt the encrypted content data field (330). The automatic execution may be implemented in a known way. Though the decrypt application is described as retrieving the key above, the operating system may be designed to retrieve the decrypt key (field 340) and provide the decrypt key to the decrypt application.

Field 360 is shown containing data specifying a time window. The time window specifies valid time durations within which access to encrypted content data (330) is permitted. For example, time window data may specify three specific days, (specifying also the corresponding month year and dates) during which the encrypted content is accessible. In an embodiment, operating system (field 310) automatically verifies if a current request (access) for the encrypted content falls within the time window specified by data in field 350, and denies accesses falling outside of the time window. The operating system (field 310) may obtain the current time at which a present access is requested from RTC 240 (FIG. 2).

Field 370 is shown containing an “access limit” which specifies a maximum number of times the encrypted content may be accessed. An access in this case may be considered as a complete decrypt operation enabling a user substantial (say more than 60% if the content accessed) use of the content unit. Thus, routine rewinds may not count towards increasing access count. In an embodiment, operating system (field 310) automatically compares a current access count against the “access limit”, and denies access if the current access count exceeds the “access limit”. The current access count may also be stored (along with access limit) in field 370 according to a pre-specified convention.

Portable storage device 140A may be connected to a hardware unit to retrieve the stored memory contents and reproduce/replay the stored encrypted content. The description is accordingly continued with a flowchart illustrating the manner in which the contents of memory 250 operate to reproduce/replay content units.

5. Replaying Content Units

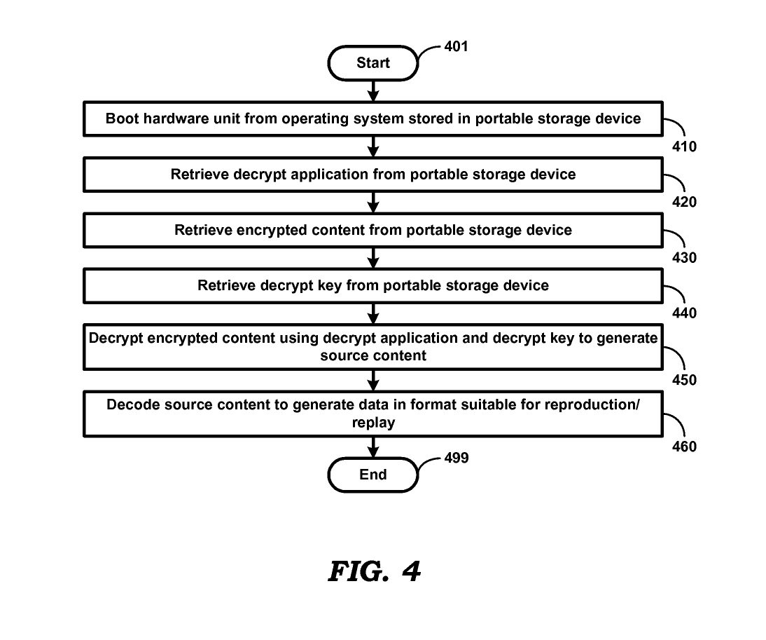

FIG. 4 is a flowchart illustrating the manner in which a content unit stored in a portable storage device is retrieved and reproduced in one embodiment. The description is provided with respect to FIGS. 1-3 (and in particular as being performed in user system 170A) merely for illustration. However, some of the features can be implemented in various other environments, as will be apparent to one skilled in the relevant arts by reading the disclosure provided herein. The flowchart starts in step 401 in which control passes immediately to step 410.

In step 410, user system 170A is booted from the operating system (field 310 of FIG. 3) stored in portable storage device 140A. The booting process causes the operating system (or instructions representing the operating system) to be loaded and executed in the hardware unit. Such a feature can be obtained, for example, by implementing a ‘bootstrap loader’ (well known in the relevant arts) in user system 170A to check for the presence of portable storage device 140A and retrieve instructions starting from the start address of field 310. Control then passes to step 420.

In step 420, user system 170A retrieves the decrypt application (field 320 of FIG. 3) from the portable storage device. In an embodiment, the operating system, upon execution, automatically retrieves the decrypt application. Control then passes to step 430.

In step 430, user system 170A retrieves the encrypted content (field 340 of FIG. 3) from the portable storage device 140A. In an embodiment, the operating system, upon execution, automatically retrieves the encrypted content. Alternatively, the decrypt application may retrieve the content on an as needed basis by interfacing with the operating system. Control then passes to step 440.

In step 440, user system 170A retrieves the decrypt key (field 350 of FIG. 3) from the portable storage device 140A. In an embodiment, the operating system, upon execution, automatically retrieves the decrypt key. Alternatively, the decrypt application (field 320 of FIG. 3) may retrieve the decrypt key. Control then passes to step 450.

In step 450, user system 170A decrypts the encrypted content (content units) by executing the decrypt application, which uses the decrypt key. A (decrypted) source content is generated as a result. The source content can represent content such as movies, audio, games, etc. Control then passes to step 460.

In step 460, the source content is decoded to generate data in a format suitable for reproduction. The content is then reproduced based on the decoded data. For example, the source content may be in a compressed form such as MPEG. The MPEG video data may be decoded by the decoder (field 330 of FIG. 3) and converted to a format suitable for reproduction on a television system. Control then passes to step 499 in which the flowchart ends.

The reproduction depends on the specific type of content units and also the reproduction system. The description is continued with respect to the manner in which video content can be conveniently reproduced in an embodiment of the user system 170A.

6.User System

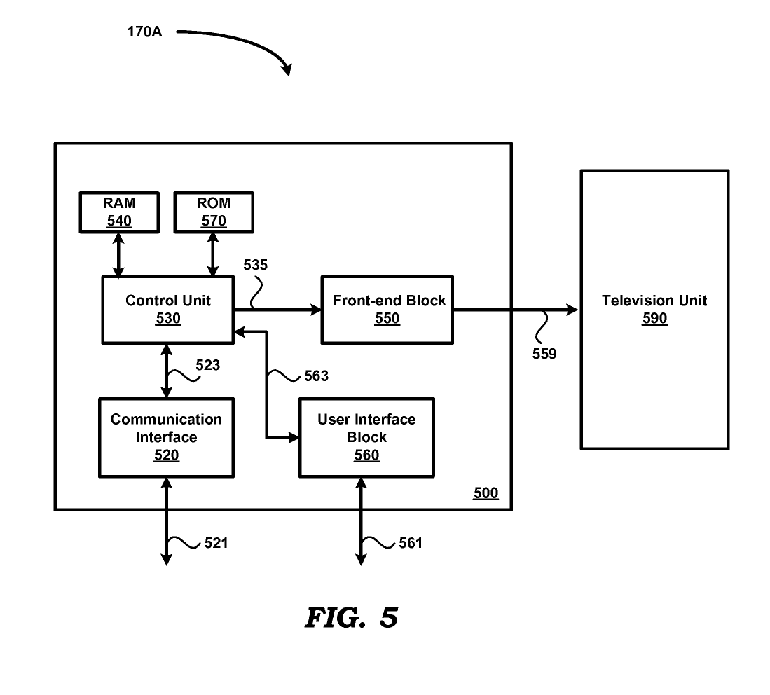

FIG. 5 is a block diagram of a user system (such as user systems 170A through 170N) designed to reproduce video content stored in a portable storage device in an embodiment. User system 170A is shown containing hardware unit 500 and television unit 590. Hardware unit 500 in turn is shown containing communication interface 520, control unit 530, random access memory (RAM) 540, front-end block 550, user interface block 560 and read only memory (ROM) 570. Each component is described in detail below.

Television unit 590 represents a device capable of reproducing the content present in television signals received from broadcasters according to corresponding standards (HDTV, NTSC, PAL, etc.). As described below, hardware unit 500 operates to provide the content in field 340 in the form of television signals (compatible with what broadcasters would be sending) such that the content can be suitably reproduced.

User interface block 560 provides output signals (e.g., indication signals to a LED/LCD panel, not shown), and receives input signals (e.g., interface with a key-pad, not shown) which can form the basis for a suitable interface (via path 561) for a user to configure and operate hardware unit 500. For example, a user may input the track number/title number of a movie that he wishes to be played if more than one movie is stored in portable storage device connected to path 521.

Communication interface 520 (under control of control unit 530) receives a data stream from a portable storage device connected on path 521 in serial form, and forwards the data stream to control unit 530 on path 523. Communication interface 520 may be implemented consistent with serial communication interfaces such as USB, SD card protocols, etc.

ROM 570 stores a bootstrap loader, which is executed upon initialization (power on or reboot) of hardware unit 500. The bootstrap loader is designed to cause control unit 530 to load operating system (field 310) into RAM 540 and start executing the instructions in RAM 540. The bootstrap loader may also check for the presence of portable storage device on path 521 prior to loading the operating system. Any non-volatile memory providing random access can be conveniently used to store the bootstrap loader. In an embodiment, the decrypt application (field 320) and decoder (field 330) are stored in ROM 570, instead of being retrieved from an external portable storage device noted above.

Control unit 530 is designed to execute the bootstrap loader in ROM 570, which causes the operating system (field 310 of FIG. 3) to be executed. The operating system in turn is designed to retrieve the data constituting the decrypt application (field 320) as described above with respect to FIGS. 3 and 4.

As further described with respect to FIG. 4, control unit 530, in conjunction with the execution of the decrypt application and decoder, generates video data (from the encrypted video content) in a form suitable for reproduction on a television system, and forwards the video data to front-end block 550 for further processing. Control unit 530 may be implemented in the form of a microcontroller/microprocessor or, in general, in the form of a digital control logic.

RAM 540 is used to store the various instructions (operating system, decrypt application, etc.,) and data (encrypted/decrypted content) noted above. Front-end block 550 receives video data representing video content from control unit 530, and processes the data to generate television signals (path 559, compatible with the standards using which broadcasters would broadcast the signals) suitable for replay (reproduction) on television unit 590.

While the hardware unit 500 and television unit 590 are shown as being implemented as separate units, alternative embodiments can be implemented integrating both into a single unit. The concepts may be applied in distribution of other types of content as well and the related description is not repeated in the interest of conciseness.

From the above, it may be appreciated that movie distribution is simplified for various distributors (e.g., rental agencies such as Blockbuster). Such simplification is also available in distributing other types of content. Further, due to the choice of content as shown in FIG. 3, enhanced control is also obtained in distribution.

The next section describes the manner in which a distribution system may take advantage of such advantages in one embodiment.

7. Distributing Source Content

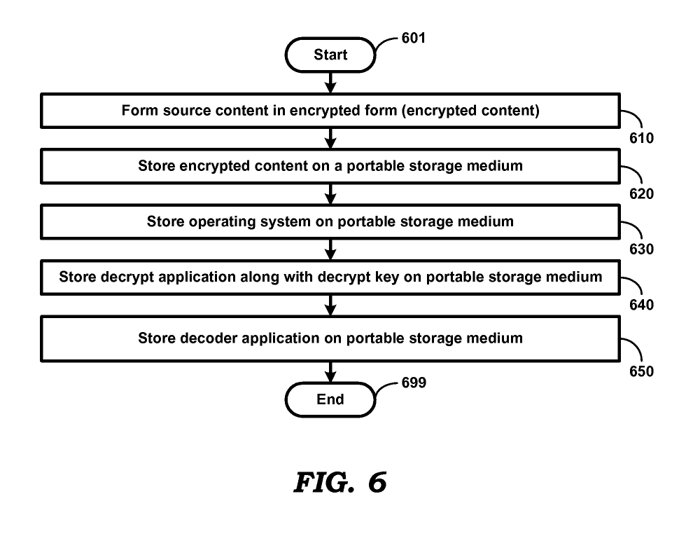

FIG. 6 is a flowchart illustrating the manner in which a source content is distributed in one embodiment. The description is provided with respect to FIG. 1 merely for illustration. However, the features can be implemented in various other environments without departing from the scope and spirit of various aspects of the present invention, as will be apparent to one skilled in the relevant arts by reading the disclosure provided herein. The flowchart starts in step 601, in which control passes immediately to step 610.

In step 610, distribution system 130 forms source content in an encrypted form. In an embodiment, source content is received in encrypted form (along with the corresponding decryption key) from content repository 110. Alternatively, the source content may be received in unencrypted form, and distribution system 130 may generate the encrypted content based on a key pair specific to the user. Control then passes to step 620.

In step 620, distribution system 130 stores the encrypted source content on a portable storage device (e.g., 140A) or the medium of FIG. 3. Control then passes to step 630.

In step 630, distribution system 130 stores an operating system on the portable storage medium. The operating system may be designed such that a hardware unit can boot from it. In addition, the operating system may also be designed, upon execution, to automatically retrieve the encrypted video content and decrypt it, as described above with respect to FIG. 3. Control then passes to step 640.

In step 640, distribution system 130 stores a decrypt application and a decrypt key on the portable storage medium. The decrypt application and decrypt key may be designed to decrypt the encrypted video content to generate a source video content. Control then passes to step 650.

In step 650, distribution system 130 stores a decoder on the portable storage medium. The decoder may be designed to decode the decrypted video content to a format suitable for reproduction on a television system. Control then passes to step 699, in which the flowchart ends.

The flowchart may thus form the machine readable medium of FIG. 3 described above. The medium can then be used to reproduce the content, also as described above with examples.

While the steps of the flowcharts are described above in specific sequence merely for illustration, it should be appreciated that some of the steps can be performed in a different sequence, without departing from the scope and spirit of several aspects of the present invention.

An embodiment of a system in which several features of the present invention are operative upon execution of corresponding software instructions, in one embodiment, is described next.

8. System

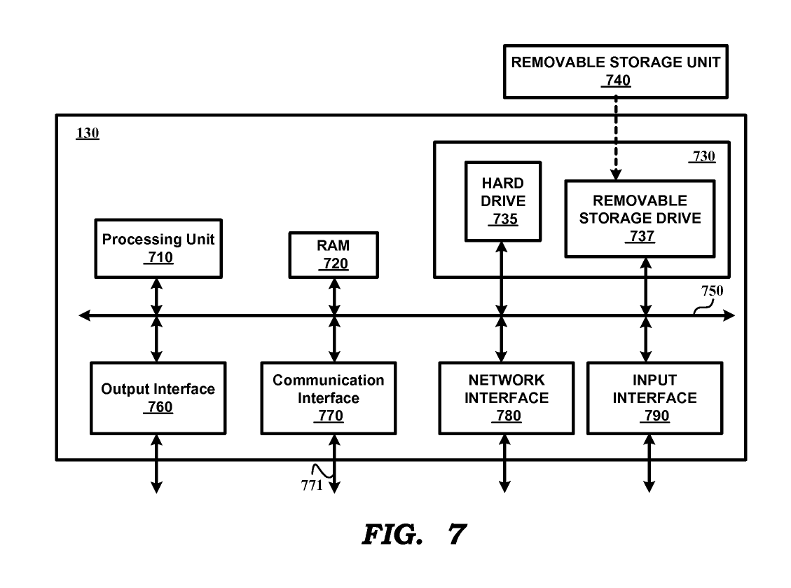

FIG. 7 is a block diagram illustrating the details of a system in which several features of the present invention are operative upon execution of corresponding software instructions, in one embodiment. Distribution system 130 is shown containing processing unit 710, random access memory (RAM) 720, storage (secondary memory) 730, removable storage unit 740, output interface 760, communication interface 770, network interface 780 and input interface 790. Each block is described in further detail below.

Output interface 760 provides output signals (e.g., display signals to a display unit, not shown) which can form the basis for a suitable interface for an operator/staff at a distribution outlet to configure/operate distribution system 130. Input interface 790 (e.g., interface with a key-board and/or mouse, not shown) enables an operator to provide any necessary inputs. For example, an operator may enter a customer's name and subscription details, borrowing/rental information, names/catalogue numbers of borrowed movies/songs etc.

Communication interface 770 sends content units for storage therein to a portable storage device (such as 140A through 140N, not shown in FIG. 7) in serial form on path 771, and may be implemented consistent with serial communication interfaces such as USB, SD card etc. A suitable socket (e.g., a USB socket) may be provided to facilitate connection of a portable storage device (or any compatible device, in general) on path 771.

Network interface 780 enables distribution system 130 to send and receive data on communication networks. For example, content units may be received via network interface 780 over a network from content repository 110. Similarly, content units may be downloaded via network interface 780 to a user's computer at the user's home, and stored on a portable storage device. Network interface 780, output interface 760 and input interface 790 may be implemented in a known way.

RAM 720 and storage 730 may together be referred to as a memory. RAM 720 receives instructions and data on bus 750 from storage 730, and provides the instructions to processing unit 710 for execution. In general, each of RAM 720 and storage 730 represents a computer readable medium from which instructions can be retrieved and executed by processors to provide the features of the present invention.

Secondary memory 730 may contain units such as hard drive 735 and removable storage drive 737. Secondary storage 730 may store the software instructions and data, which enable distribution system 130 to provide several features in accordance with the present invention. While secondary memory 730 is shown contained within distribution system 130, an alternative embodiment may be implemented with the secondary memory 730 implemented external to distribution system 130, and the software instructions may be provided using network interface 780.

Some or all of the data and instructions may be provided on removable storage unit 740 (or from a network using protocols such as Internet Protocol), and the data and instructions may be read and provided by removable storage drive 737 to processing unit 710. Floppy drive, magnetic tape drive, CD_ROM drive, DVD Drive, Flash memory, removable memory chip (PCMCIA Card, EPROM) are examples of such removable storage drive 737.

Processing unit 710 may contain one or more processors. Some of the processors can be general purpose processors which execute instructions provided from RAM 720. Some can be special purpose processors adapted for specific tasks. The special purpose processors may also be provided instructions from RAM 720.

In general processing unit 710 reads sequences of instructions from various types of memory media (including RAM 720, storage 730 and removable storage unit 740), and executes the instructions to provide various features of the present invention. In general, the various memory units (removal or not, random access or otherwise, read-only or not, volatile or non-volatile) represents a machine readable medium from which processing unit 710 reads the instructions to provide the features described above.

9.Conclusion

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A storage medium to distribute a source content, said storage medium comprising:
a first set of bits constituting an operating system from which a device can boot;
a second set of bits constituting an encrypted content, wherein said encrypted content represents said source content encrypted according to an encryption approach, said encryption approach requiring a key to decrypt said encrypted content;
a third set of bits representing said key; and
a fourth set of bits comprising an application implementing a decryption approach complementing said encryption approach, wherein said application upon execution in said device decrypts said encrypted content using said third set of bits.

2. The storage medium of claim 1, wherein said operating system is designed to execute said fourth set of bits automatically.

3. The storage medium of claim 2, wherein said third set of bits are stored in a location in said storage medium, one of said first set of bits and said fourth set of bits being designed to retrieve said third set of bits in said location and provide said key to said application to decrypt said encrypted content.

4. The storage medium of claim 2, further comprising a seventh set of bits specifying a time window, said encrypted content being accessible only within said time window.

5. The storage medium of claim 4, further comprising an eighth set of bits specifying an access limit, said encrypted content being accessible only if a current access number is less than said access limit.

6. The storage medium of claim 5, wherein said operating system is designed to execute said application only if a current time falls within said time window, and said current access number is less than said access limit.

7. The storage medium of claim 6, further comprising:
a fifth set of bits constituting a decoder, wherein said decoder upon execution in said device converts said source content to a sixth set of bits according to a format suitable for reproducing said source content, said operating system being designed to execute said fifth set of bits automatically without requiring human intervention, and said operating system providing said sixth set of bits to a content reproduction circuit.

8. The storage medium of claim 7, comprising a communication interface according to the universal serial bus (USB) standard, wherein said storage medium communicates with said device via said communication interface.

9. The storage medium of claim 8, wherein said second set of bits constitutes video content.

10. A method of distributing a source content to a plurality of users, said method comprising:
forming an encrypted content, wherein said encrypted content is generated from said source content using a first key of a key pair according to an encryption approach, a decryption approach requiring a second key of said key pair to decrypt said encrypted content;
storing said encrypted content on a single storage medium;
storing on said single storage medium an operating system from which a device can boot; and
storing on said single storage medium said second key; and
storing on said single storage medium a first set of bits comprising an application implementing said decryption approach, wherein said application upon execution in said device decrypts said encrypted content using said second key.

11. The method of claim 10, wherein said operating system is designed to execute said application automatically.

12. The method of claim 11, wherein said second key is stored in a location in said single storage medium, one of said operating system and said first set of bits being designed to retrieve said second key in said location and provide said second key to said application to decrypt said encrypted content.

13. The method of claim 11, further comprising storing on said single storage medium a first data specifying a time window, said encrypted content being accessible only within said time window.

14. The method of claim 13, further comprising storing on said single storage medium a second data specifying an access limit, said encrypted content being accessible only if a current access number is less than said access limit, wherein said operating system is designed to execute said application only if a current time falls within said time window and said current access number is less than said access limit.

15. The method of claim 14, wherein said encrypted content, said first set of bits, said operating system, said second key, said first data and said second data are stored in said single storage medium via a communication interface designed according to the universal serial bus (USB) standard.

16. A device for distributing a source content to a plurality of users, said device comprising:
a communication interface designed to communicate with a storage medium; and
a processing unit forming an encrypted content, an operating system, a first set of bits comprising an application, and a decrypt key required to decrypt said encrypted content, said encrypted content being formed using an encrypt key according to an encryption approach,
said processing unit being designed to store each of said encrypted content, said operating system, said first set of bits, and said decrypt key on a single storage medium via said communication interface, said first set of bits implementing a decryption approach complementing said encryption approach, wherein said application upon execution is designed to decrypt said encrypted content using said decrypt key.

17. The device of claim 16, wherein said operating system is designed to execute said application automatically.

18. The device of claim 17, wherein said forming comprises one of receiving said encrypted content, said operating system, said first set of bits, said encrypt key and said decrypt key, and generating said encrypted content, said operating system, said first set of bits, said encrypt key and said decrypt key.

19. The device of claim 18, wherein said communication interface is a USB interface.

20. The device of claim 19, wherein said processing unit stores a decoder application on said single storage medium, said decoder application, when executed, being designed to convert said source content to a format suitable for being reproduced, said operating system being designed to execute said decoder application automatically without requiring human intervention.

21. A hardware unit for reproducing a video content on a television system, said television system being designed to reproduce said video content received in the form of a television signal, said hardware unit comprising:
a communication interface to communicate with a storage device, wherein said storage device has stored therein an operating system, an encrypted video content, a decrypt key, wherein said operating system is designed, upon being loaded onto said hardware unit, to automatically execute a decrypt application and decrypt said encrypted video content using said decrypt key to generate said video content;
a memory storing a bootstrap loader designed to load said operating system onto said hardware unit;
a controller executing said bootstrap loader to retrieve from said storage device and execute said operating system, and to decrypt said encrypted video content to generate said video content, and
a front-end block to process said video content to generate said television signal representing said video content, and providing said television signal to said television system.

22. The hardware unit of claim 21, wherein said hardware unit is integrated into said television system.

23. A method of distributing a video content to a plurality of users, said method comprising:
forming an encrypted video content, wherein said encrypted video content is generated from said video content using a first key of a key pair according to an encryption approach, said encryption approach requiring a second key of said key pair to decrypt said encrypted video content;
storing said encrypted video content on a single storage medium;
storing on said single storage medium an operating system from which a device can boot;
storing on said single storage medium said second key; and
storing on said single storage medium a first set of bits comprising an application implementing a decryption approach complementing said encryption approach, wherein said application upon execution in said device decrypts said encrypted video content using said second key.

24. The method of claim 23, wherein said operating system is designed to execute said application automatically.

25. The method of claim 24, wherein execution of said application decrypts said encrypted video content to generate said video content, said video content being decoded by a decoder to generate television signals representing said video content, said television signals being provided to a television unit to reproduce said video content.

26. The method of claim 25, wherein said single storage medium is contained in a USB thumb drive.
